(19) United States
(12) Patent Application Publication
(10) Pub. No.: US 2011/0238603 A1
(43) Pub. Date: Sep. 29, 2011

(54) System and Method for Predicting Events Via Dynamic Ontologies

(75) Inventors: Bruce E. Peoples, State College, PA (US); Robert J. Cole, Pa. Furnace, PA (US); Jonathon P. Smith, Port Matilda, PA (US)

(73) Assignee: Raytheon Company, Waltham, MA (US)

(21) Appl. No.: 12/748,514

(22) Filed: Mar. 29, 2010

(51) Int. Cl. G06F 15/18; G06N 5/02

(52) U.S. Cl. 706/12; 706/52; 706/47; 706/50

(57) ABSTRACT

Disclosed is a system and method for determining the probability of an event occurring. The method involves developing models relating a number of factors and variables. The factors and variables can be unique to a specified field of endeavor, such as military security or epidemiology. The models can be ontological models. A rule set is then utilized to relate certain variables in the models to a specific event. The rule set can be embodied in a computer model, such as a Bayesian-Network. The system permits a user to query a knowledge store or database to acquire referent values for the rule set. Thereafter, the referent values are used to populate the rule set and compute the probability of the event occurring.

### TECHNICAL FIELD

This disclosure relates to a method for predicting the occurrence of an event. More specifically, the disclosure relates to a system and method for predicting a specific event using dynamic ontologies.

### BACKGROUND OF THE INVENTION

There are over 500 billion gigabytes of digital information in the world today. Starting in 2010, the total amount of digital information in existence will begin to increase exponentially. No one human is capable of reviewing this information, much less making sense of it. No matter the domain of interest, humans cannot be expected to find the nuggets of critical information in this sea of data, information, and knowledge. Complicating matters is that in today's information society, data, information, and knowledge are often distributed across vast computer networks.

As a result of this ever growing sea of data and the distribution thereof, there is a need for computer based information technology (“IT”) applications that can sift through huge amounts of digital data to find content that is current, relevant, and contextually appropriate. The goal of any such IT system is to assist a human user, or in some cases a digital agent representing a human user, in quickly discovering relevant data, information, and knowledge that would be impossible to discover by human effort alone due to the extremely large data sets, knowledge stores, and associated computer networks.

The need for processing large amounts of digital data is especially acute in the area of national security. We are faced today with increasing threats from adversaries around the world. The solemn task of protecting against future attacks rests with the world's intelligence agencies. Intelligence agencies are constantly investigating potential threats so that any adversarial activities can be timely thwarted. In doing so, agencies must process large volumes of information in order to uncover any hints, clues, or insights about potential attacks. These agencies need vastly improved IT systems so they can effectively and timely “connect the dots” and ensure that any opportunity to thwart a planned attack is not lost.

But the need to process large amounts of digital data is not exclusive to intelligence agencies. The need arises in a wide variety of fields. These fields include, for example, medicine and epidemiology. A large percentage of the information currently stored on today's computers relates to medical records. Health agencies have a continuing need for a more effective means to review and make sense of this information. The ability for health care workers to meaningfully review data on emerging diseases would help in anticipating future epidemics and pandemics. This, in turn, would lead to the timely production of vaccines.

Ultimately, there is a growing need in many different fields for improved IT systems that allow human users to systematically review large data sets or knowledge stores in order to obtain information that is relevant, timely, and contextually appropriate.

### SUMMARY OF THE INVENTION

This disclosure provides both a system and a method for determining the occurrence of an event. The method involves developing models relating a number of factors and associated variables. A rule set is then utilized to relate certain variables to the occurrence of a specified event. A knowledge store or database can be queried to determine referent values for the rule set. Thereafter, the referent values are used to populate the rule set and compute the probability of the event occurring. In one embodiment, the models are dynamic ontologies and the rule sets are carried out via Bayesian-Networks.

The disclosed system has several important advantages. For example, the method permits users to more effectively comb through large amounts of data by screening out irrelevant and/or inconclusive data sets.

A further possible advantage is the ability to use computer modeling to detect patterns in large amounts of data that would otherwise be overlooked by a human user.

Still yet another possible advantage of the present system is to create a dynamic ontology wherein seemingly routine facts can be associated with specific events of interest to the user.

The present system also provides for an easily scalable network that is capable of processing small or large amounts of data.

Another advantage of the present system is to graphically display both ontological models and associated computational models so that users can visually comprehend the relationship between key variables and associated events.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a flow chart illustrating a method carried out in accordance with the present disclosure;

FIG. 2 is a diagram of two different ontological models created in accordance with the disclosed method;

FIG. 3 is a diagram illustrating how the two different ontological models can be related via a computational network;

FIG. 4 is a diagram illustrating a more specific implementation of the diagram of FIG. 2.

FIG. 5 is a diagram illustrating a more specific implementation of the diagram of FIG. 3.

FIG. 6 is a graphic illustration of a computational model relating two variables to a specific event.

FIG. 7 is an example of a conditional probability table employed by the computational network of the present invention.

### DETAILED DESCRIPTION OF THE DRAWINGS

Disclosed is a system and method for determining the probability of an event occurring. The method involves developing models relating a number of factors and variables. The factors and variables can be unique to a specified field of endeavor, such as military security or epidemiology. The models can be ontological models. A rule set is then utilized to relate certain variables in the models to a specific event. The rule set can be embodied in a computational model, such as a Bayesian-Network. The system permits a user to query a knowledge store or database to acquire referent values for the rule set. Thereafter, the referent values are used to populate the rule set and compute the probability of the event occurring. The system can be code implemented on a computer-readable medium and executed on a processor.

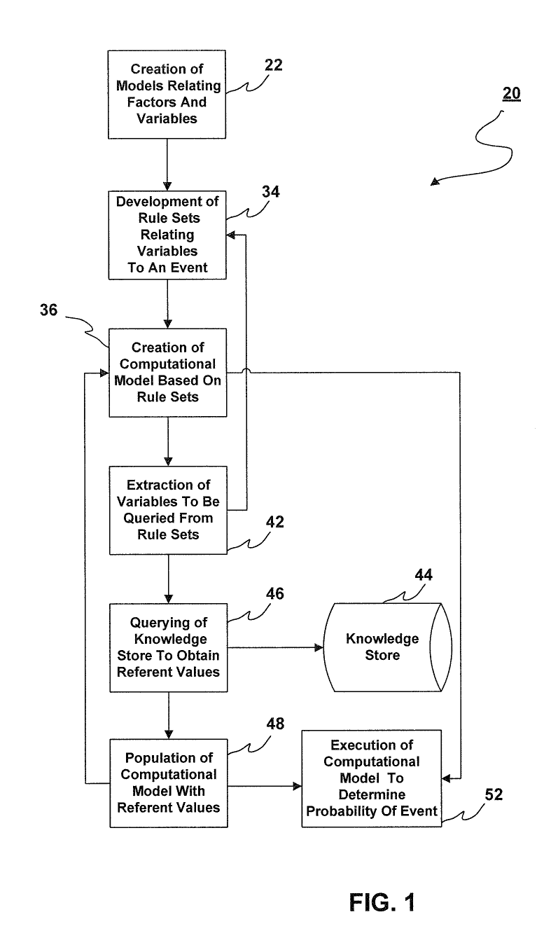

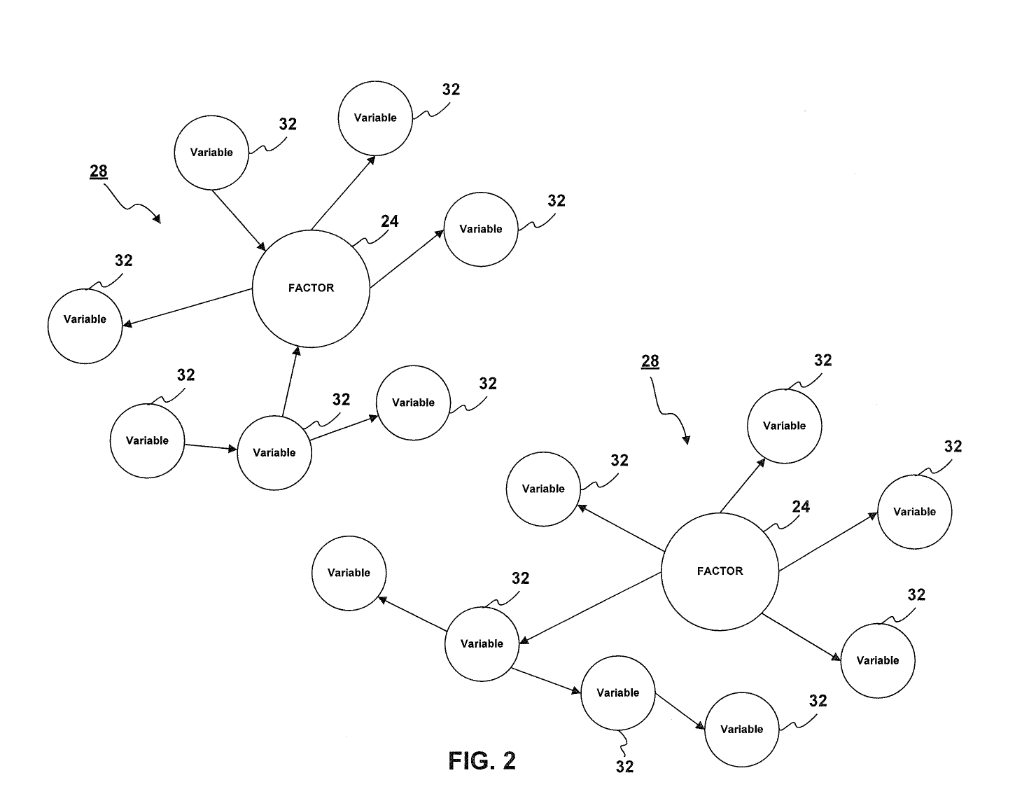

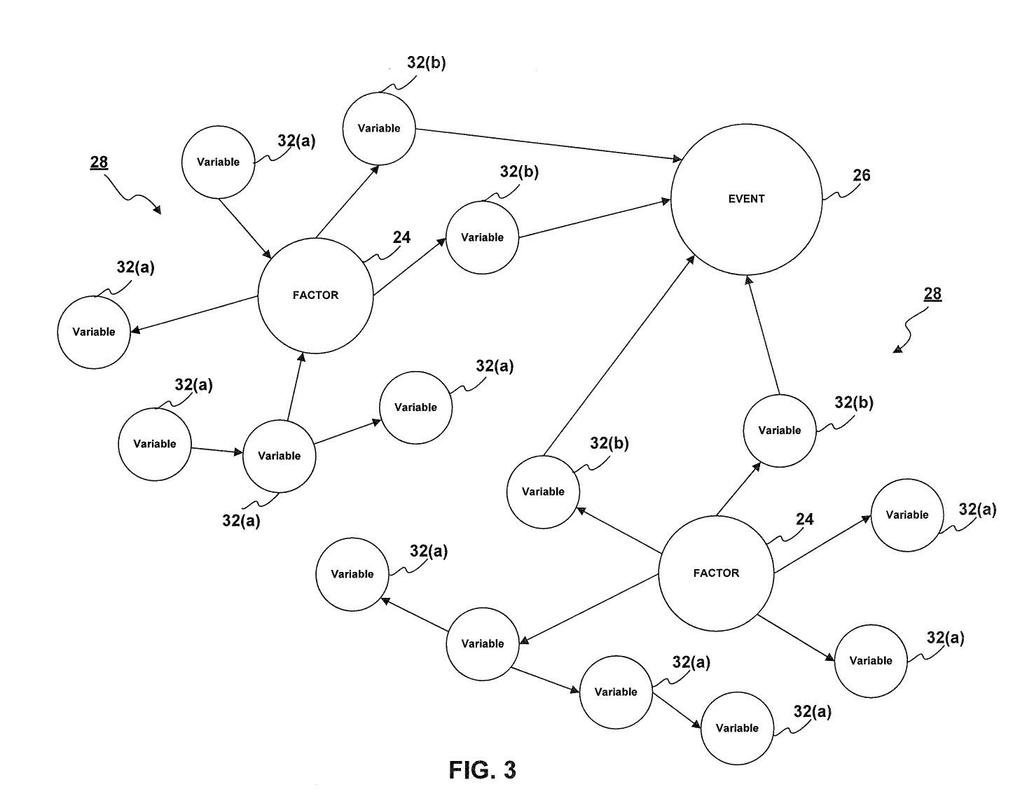

FIG. 1 is a flow chart depicting one possible embodiment 20 of the disclosed method. In the first step 22, a number of factors 24 are identified that potentially relate to an event 26 being investigated (note FIGS. 2 and 3). Models 28 are created relating each of the identified factors 24 to a number of variables 32. Models 28 can be, for example, dynamic ontological models resident on a network server running an existing ontology editor such as Protégé and created using the Web Ontology Language (OWL) or Resource Description Frameworks (RDF). FIGS. 2 and 3 are graphic representations of the ontologies that would be presented to the user via the ontology editor.

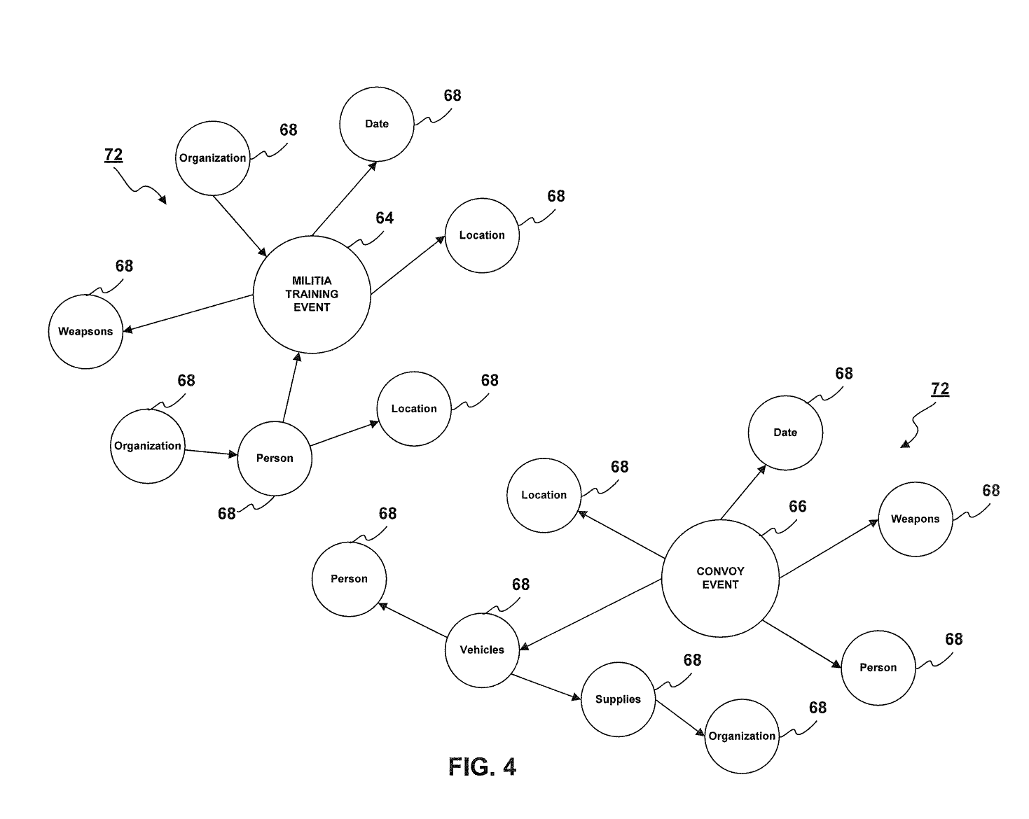

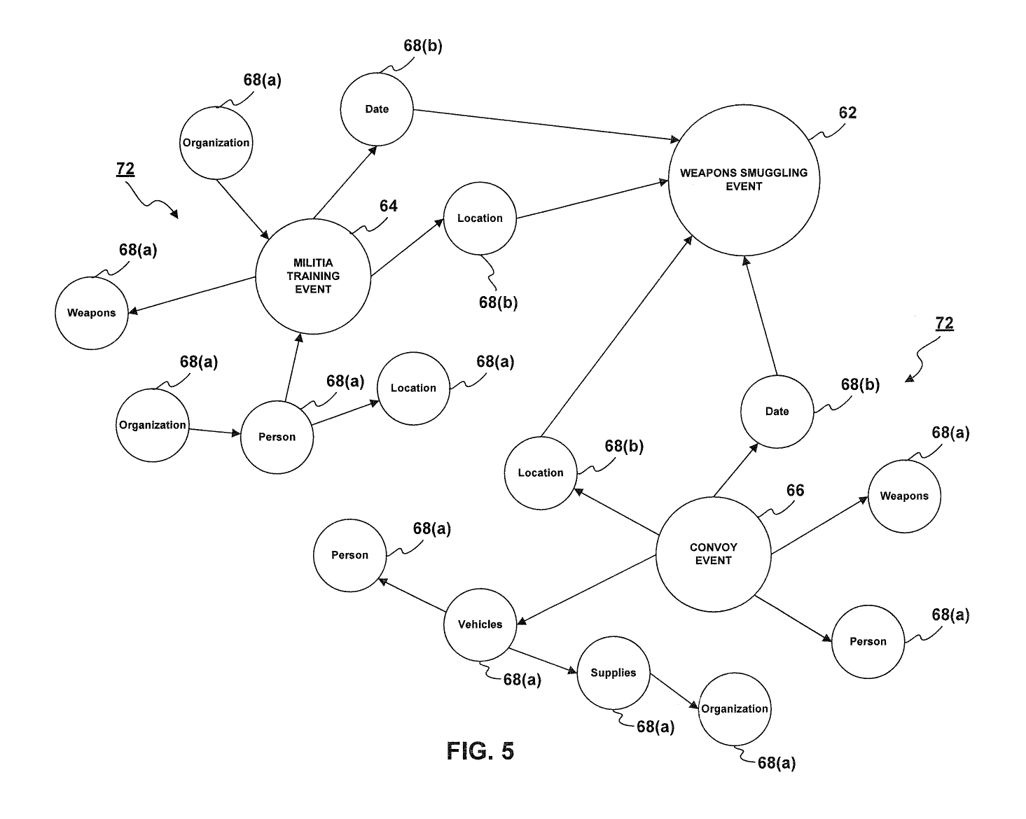

As noted more fully hereinafter, the event 26 being investigated can be, for example, the possibility of an adversarial event, such as a weapons smuggling event (note FIG. 5). In this embodiment, the factors 24 correspond to the tactics, techniques, and procedures of the adversary. Specific examples include such things as militia training events or convoy events (note FIG. 4). In this example, the variables 68 associated with factors 64 correspond to things such as the date and location of the training or convoy event (FIG. 4). Other variables 68 can be facts such as the names of individuals associated with the militia training or convoy. However, the system and method disclosed herein are not limited to military related uses.

The system and method can be employed in other environments, such as medicine or epidemiology. In this instance, the event 26 being investigated could be, for example, a medical diagnosis, such as cancer, diabetes, or heart disease. Factors 24 would relate to things such as the physical symptoms of the patient. These symptoms could include chest pains, shortness of breath, or headaches. Variables 32 would correspond to details regarding the patient, such as sex, age, or a prior diagnosis.

Regardless of the field of endeavor, the user must identify a number of possible events. Then, in the second step 34, at least one rule set is developed for each event 26. Each rule set, in turn, relates certain key variables 32(b) from two or more of the models 28 (created in step 22) to one or more specific events 26. In essence, the rule sets are developed to predict the occurrence of an event 26 on the basis of key variables 32(b) (note FIG. 3). In one embodiment, the rule sets are basic if-then statements. Simple Boolean techniques can also be incorporated. For example, the output of the “If” statement can exist as being either true or false. The “then” statement can specify an occurrence, such as an event occurrence that could exist if the “if” statement is true. The occurrence, such as an event occurrence, is conditional in the context of variables in the “if” statement being “true.”

At step 36 a computational model is created for each of the rule sets developed in step 34. In an illustrative but not limiting example, the computational model is a Bayesian-Network with input variables and an output variable. The input variables of the network correspond to the key variables 32(b) identified in step 34. The output variable corresponds to an event 26. The computational model also includes a conditional probability table 38 (note FIG. 7) specifying the existence of the output variable based upon the input variables. The conditional probability table 38 can, therefore, be used to specify the probability of a specific event 26 occurring based on historical data or a prior statistical analysis. In this way, table 38 can be used to link the key variables 32(b) of one or more models 28 to a specific event via conditional relationship edges.

Thereafter, at step 42, the user interfaces with the system by first identifying a specific event 26 to investigate. On the basis of the identified event 26, key variables 32(b) are extracted from one or more rule sets. These key variables 32(b) represent the variables to be subsequently queried. This is a preparatory step to mining appropriate data, information, or knowledge. The mined data is then utilized in the computational models as described hereinafter.

For computational purposes, concepts extracted must have referents returned by the query. If no referents exist, then the computations are not possible. For congruency and quality purposes, terms representing key variable 32(b) used in the rule sets developed in step 34 and terms representing the input variables for the computational models developed at step must be semantically equivalent. Query returns with no referents for the key variables 32(b) used in the rule set computations must be discarded.

A knowledge store 44 is queried in step 46 to obtain referent values for the extracted key variables identified in step 42. Additional supporting information may be discovered at this step and used for analytical use beyond that required for the computational model. Knowledge store 44 can be a computer data base storing vast quantities of data or documents.

If the returned queries contain no referent data for the key variables 32(b) of the models 28, the return is discarded. If available, supporting information, such as referents for non-key variables 32(a) are also returned for analytical use by a human user or other analytic system functions. If there are no referents for non-key variables 32(a), but there are referents for key variables 32(b), the return is considered valid. Missing referents for non-key variables 32(a) of the models 28 can be used as a basis for collecting workflows to obtain missing data and information.

At step 48, a specific computational model is identified on the basis on the specific event 26 being investigated. For instance, if a weapons smuggling event is being investigated, the computational models having outputs that semantically correspond to a weapons smuggling event will be identified. The referent values obtained at step 46 are then used to populate the input variables of the computational model. At this step, based on valid query returns, extracted referents for the key variables 32(b) are used as inputs for computations based on the rule sets developed in step 34. If the computed values resolve the rule set, or part of the rule set to a true or false condition, the appropriate column in the conditional probability table 38 is populated. Based on the true/false conditions set in the probability table 38, threshold values for the existence of a conditional output variable can be identified.

Finally, at step 52, the computational model and conditional probability table 38 are executed to determine the existence of the output variable and the probability of an event 26. This step involves the determination of the probability for the existence of an output variable used to link and display existing key variables 32(b) of models 28 with conditional relationship edges. In step 36, values for the threshold values were set for the conditional existence of the output variable. The determination of a specific threshold value is based on the contents of the conditional probability table 38. For example, if the conditional probability table 38 indicates a true/true, the threshold value for the possible existence of an output variable might be 90%. If the contents of the conditional probability table 38 are false/false, the threshold value for the possible existence of an output variable might be 5%. A 90% value would be a significant value indicating the probable existence of the event. Conversely, a 5% value would not be a significant value, thereby indicating the probable nonexistence of the event. The results can, thereafter, be graphically presented to the user (note FIG. 3)

### Method for Detecting Adversarial Events

A specific implementation of the method in the context of a military event is next described in connection with FIGS. 4-7. Here, the military event under investigation can be any of a variety of activities carried out by a military adversary. The specific event being investigated in FIGS. 4-5 is a weapons smuggling event 62. However, the method disclosed can just as easily be any number of potential adversarial events, such as road side bombs, ambushes, or sabotage. FIG. 4 graphically illustrates the first step 22 of the method. Namely, ontological models are created to relate specific tactics, techniques or procedures to a number of variables. These ontologies would be graphically presented to the user.

The variables can be any fact associated with a specified tactic, technique, or procedure. In the depicted embodiment, the model graphically illustrates variables relating to two tactics: a militia training event 64 and a convoy event 66. The adversary in this context may be a terrorist or insurgency group. The models 72 in this example are ontological models produced via an ontology editor, such as Protégé, and resident on an ontology server. Models 72 are stored in a service repository for access by a user via a graphic user interface and for future use by analytic functions.

The next step 34 is illustrated in FIG. 5. Here, rule sets are developed to describe a number of events that could potentially be carried out by the adversary. In the depicted example, a rule set is developed to define a weapon smuggling event 62 and relate it to variables 68 from two or more ontological models 72. The rule sets can take the form of simple “IF THEN” statements. For example, existing military intelligence may show that a weapons smuggling event 62 may be more likely to transpire if a militia training event 64 occurs within 14 days of a convoy event 66, and if the location of the militia training event 64 is within 10 Kilometers of the convoy event 66. In this case, the key variables 68(b) are the location and date of the events.

The appropriate rule set developed is: “If a militia training event occurs within 14 days of a convoy event, and if the militia training event occurs within 10 KM of the convoy event, then a weapon smuggling event is highly likely.” The simple compound “IF-THEN” rule set is akin to a Boolean Expression where the output can be expressed as true, false or a combination of true/false variables based on a computation. The true/false variables are intended for subsequent use generating a corresponding computational model.

In this example, if a militia training event 64 occurs within 14 days of a convoy event 66, a true condition is determined for that part of the rule set. If the training event occurs within 10 KM of a convoy event 66, then a true condition is determined for that part of the rule set. Conversely, if a militia training event 64 did not occur within 14 days of a convoy event 66, a false condition is determined for that part of the rule set.

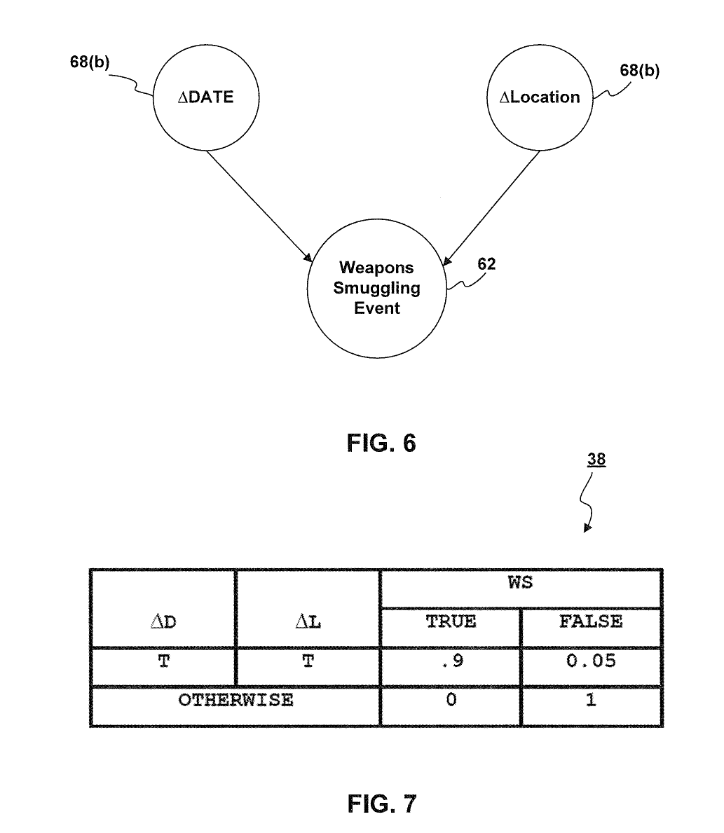

In the next step, a computational model and the associated conditional probability table 38 are generated on the basis of the rule sets. In the illustrated example, the computational model is a Bayesian-Network that may be graphically presented to the user as illustrated in FIG. 5. As noted in FIG. 6, computations were performed to determine the delta value of the referents for the “date” and “location” key variables 68(b). For example, the delta value for the date key variable 68(b) may be 14 days, and the delta value for the location key variable 68(b) may be 10 KM. In referring to the rule set from the previous step, if the date of a militia training event 64 occurs within 14 days of a convoy event 66, then a true condition is set for that part of the rule set. If the location of a militia training event 64 occurs within 10 KM of a convoy event 66, then a true condition is set for that part of the rule set.

The appropriate “input variable” slots of the condition probability table 38 are next populated with the determined conditions. A conditional probability table 38 is illustrated in FIG. 7. In this example, true conditions are set for both delta date (ΔD) and delta location (ΔL). The computational model also contains an “output variable,” which in this case is the probability of a weapons smuggling event 62. Threshold values were set for the conditional existence of the weapons smuggling event 62. Based on the example, since the values for the deltas for date and location key variables 68(b) are true, the threshold value for the conditional existence of the weapons smuggling event 62 was determined to be 90%. If the values for the deltas for date and location key variables 68(b) in the table were false, then the threshold value for the conditional existence of a weapons smuggling event 62 would have been determined to be, for example, 5%. The specific probabilities would be established via historical data and/or military intelligence. Thus, the weapons smuggling event 62 is predicted by the computational model with “conditional” edges linking the conditional event 62 with key variables 68(b) of the model 72.

When the foregoing steps have been carried out, a user can then employ the system to determine the probability of a specific adversarial event occurring. Here, the user first identifies a specific adversarial event to be investigated. Namely, because the system can store a large number of events and associated computational models, a specific event must be identified in order to execute the method. Assuming the user identifies a weapons smuggling event 62, an extractor is then used to obtain the corresponding key variables 68(b) to be queried. Commercially available software, such as NetOwl®, can be used to extract the terms date and location from the rule set. The extractor also could extract the key variables 68(b) from the computational models. In this example, the rule sets and the computational models used the same terms for the key variables; namely, “date” and “location.” It is possible, however, that different terms could be used to express the same concept. In such cases, Formal Concept Analysis (FCA) algorithms could be used to check for semantic equivalencies.

Next, the extracted key variables are used to query a database or knowledge store 44. For this specific example, a database containing documents concerning the adversary was queried by the system. However, the knowledge store 44 can be any database storing information relating to the variables and/or related factors. A query/extraction product was utilized to examine the documents and extract referents for key variables 68(b) and non-key variables 68(a) in the previously established ontological models 72. The ontological models 72 could be imported into existing and commercially available query/extraction products such as NetOwl® or Riverglass®. An exemplary document within the knowledge store 44 may contain extracted information on a previous militia training event. Another exemplary document may contain information on a convoy event. Some referents may be returned for non-key variables 68(a) in the computational models, such as the person who conducted the militia training, the organization trained, etc. These non-key variables 68(a) may be nonetheless returned to be independently reviewed by the user.

The following step involves populating the input variables of the computational model with the extracted referent values. In the cited example, the query returned valid referent information found in two documents, one document containing information on a militia training event 64, and another document containing information on a convoy event 66. Specific referents were extracted for the key variables 68(b) of date and location. Non-key referent variables 68(a) were also returned for the militia training event and convoy event. Associated graphs (FIGS. 4 and 5) were generated for the user.

In the example, the referent for the key variable date in the militia training event 64 was Aug. 10, 2004. The referent for the key variable date in the convoy event 66 was 2004-08-04. An analytic mediation function could be used to reformat the referent to match one another. Namely, the date key variable 68(b) for the militia training event could be reformatted from Aug. 10, 2004 to 2004-08-10 (the ISO standard format). A computation is made to determine the date delta between the militia training event 64 and convoy event 66. The computation determined the militia training event 64 occurred six days after the convoy event 66. Based on the rule set “If militia training event occurs within 14 days of a convoy event”, the prototype system sets a true condition for that part of the rule set. A “T”, indicating true, was placed in the AD column of the conditional probability table 38 (note FIG. 7). A computation was also made to determine the distance delta between the militia training event 64 and the convoy event 66. The computation determined the militia training event 64 and the convoy event 66 occurred in the same city. The delta computed was 0 KM. Based on the rule set segment “If the militia training occurs within 10 KM of convoy event destination”, the system set a true condition for that part of the rule set. A “T”, indicating true, was placed in the ΔL column of the conditional probability table 38 (note FIG. 7).

In the final step, the computational model is executed to determine the probability of the adversarial event 62 occurring. In this example, the threshold values for the computational model were set for the conditional existence of the output variable representing a weapons smuggling event 62. As shown in FIG. 7, the threshold value for a true/true combination for the input variables ΔD and ΔL was set at 90%. The threshold value for a false/false combination for the input variables ΔD and ΔL was set at 5%. Based on the extracted referent values, the input variables ΔD and ΔL were populated with true/true values. Based on the true/true values, the system determined the threshold value of 90% was a significant value indicating the probable existence of a weapons smuggling event 62. The determined probable existence of the weapons smuggling event 62 allowed the system to create the probable concept node Weapon Smuggling Event (FIG. 6). The system also creates conditional links based upon the conditional probability table linking the date and location nodes 68(b) to the weapon smuggling node 62.

A dynamically created ontology is thereby defined by the output variable of the Bayesian-Network model, the conditional links formed, and specific a priori ontological models. In the example of FIG. 5, the dynamically created ontology, Weapons Smuggling Event ontology, conditionally links key variables 68(b) in an a priori militia training event model 64, and key variables 68(b) in an a priori convoy event model 66 to the probable concept weapon smuggling event node 62, through the use of a computational model, such as a Bayesian-Network.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for detecting the probability of a specific event occurring, the method employing a dynamic ontology and Bayesian-Networks, the method comprising the following steps:
identifying tactics, techniques, and procedures, and creating an ontological model for each of the identified tactics, techniques, and procedures, each ontological model graphically relating a tactic, technique, or procedure to a number of variables and key variables;
developing at least one rule set for each of a plurality of events, each rule set relating the key variables of two or more models to at least one of the plurality of events;
creating a Bayesian-Network model for each of the developed rule sets, each Bayesian-Network model having input variables and an output variable, wherein the input variables corresponds to the key variables and the output variable corresponds to at least one of the events, and wherein each Bayesian-Network model includes a conditional probability table specifying the probability of the output variable based upon the input variables;
extracting the key variables to be queried from the rule sets on the basis of the specific event;
querying a knowledge store to obtain referent values for the extracted key variables;
identifying one of the Bayesian-Network models on the basis of the specific event and populating the input variables of the identified Bayesian-Network model with the referent values;
executing the identified Bayesian-Network model to determine the existence of the output variable and the probability that the specific event will occur.

2. A method for detecting the probability of an event occurring comprising the following steps:
identifying a number of factors and creating a corresponding model for each of the identified factors, each model graphically relating the factors to a number of variables;
developing a rule set for the event, the rule set relating the variables of two or more models to the of event;
creating a computational model for each of the developed rule sets, each computational model having input variables and an output variable, wherein the input variables corresponding to the variables of the rule sets and the output variable corresponding to the events;
querying a database to obtain referent values for the input variables;
executing the computational model to determine the existence of the output variable and the probability that the event will occur.

3. The method as described in claim 2 wherein an ontology is developed to relate each identified factor to a number of different variables.

4. The method as described in claim 2 wherein a Bayesian-Network is developed for each of the rule sets.

5. The method as described in claim 2 wherein the factors are selected from the group consisting of tactics, techniques, and procedures.

6. The method as described in claim 2 wherein the factors are selected on the basis of the physical symptoms of a patient.

7. The method as described in claim 2 wherein the event corresponds to an adversarial event.

8. The method as described in claim 2 wherein the event corresponds to a medical diagnosis.

9. The method as described in claim 2 wherein the computational model includes a conditional probability table specifying the probability of the output variable based upon the input variables.

10. A method for detecting the probability of a specific event occurring, the method employing dynamic ontologies and Bayesian-Networks, the method comprising the following steps:
identifying a number of factors and creating a corresponding ontological model for each of the identified factors, each ontological model relating the factors to a number of variables and key variables;
developing at least one rule set for each of a plurality of events, each rule set relating the key variables of two or more models to at least one of the plurality of events;
creating a Bayesian-Network model for each of the developed rule sets, each Bayesian-Network model having input variables and an output variable, wherein the input variables correspond to the key variables and the output variable corresponds to at least one of the events, and wherein each Bayesian-Network model includes a conditional probability table specifying the probability of the output variable based upon the input variables;
extracting the key variables to be queried from the rule sets on the basis of the specific event;
querying a knowledge store to obtain referent values for the extracted key variables;
identifying one of the Bayesian-Network models on the basis of the specific event and populating the input variables of the identified Bayesian-Network model with the referent values;
executing the identified Bayesian-Network model to determine the existence of the output variable and the probability that the specific event will occur and visually displaying the results to the user.

11. The method as described in claim 10 wherein the factors are selected from the group consisting of tactics, techniques, and procedures.

12. The method as described in claim 10 wherein the factors are selected on the basis of the physical symptoms of a patient.

13. The method as described in claim 10 wherein the event corresponds to an adversarial event.

14. The method as described in claim 10 wherein the event corresponds to a medical diagnosis.

15. Code implemented on a computer-readable medium, when executed by a processor, operable to compute the probability of a specific event as follows:
identifying a number of factors and creating a corresponding model for each of the identified factors, each model relating an identified factor to a number of variables;
developing at least one rule set for each of a plurality of events, each rule set relating the variables of two or more models to at least one of the plurality of events;
identifying variables to be queried on the basis of the specific event;
querying a knowledge store to obtain referent values for the identified variables;
identifying a rule set on the basis of the specific event and populating the identified rule set with the referent values;
executing the identified rule set to determine the probability that the specific event will occur.

16. A method for dynamically creating an ontology that detects the probability of a specific event occurring, the method employing a computational model such as a Bayesian-Network, the method comprising the following steps:
identifying tactics, techniques, and procedures, and creating an ontological model for each of the identified tactics, techniques, and procedures, each ontological model graphically relating a tactic, technique, or procedure to a number of variables and key variables;
developing at least one rule set for each of a plurality of events, each rule set relating the key variables of two or more models to at least one of the plurality of events;
creating a Bayesian-Network model for each of the developed rule sets, each Bayesian-Network model having input variables and an output variable, wherein the input variables correspond to the key variables and the output variable corresponds to at least one of the events, and wherein each Bayesian-Network model includes a conditional probability table specifying the probability of the output variable based upon the input variables;
extracting the key variables to be queried from the rule sets on the basis of the specific event;
querying a knowledge store to obtain referent values for the extracted key variables;
identifying one of the Bayesian-Network models on the basis of the specific event and populating the input variables of the identified Bayesian-Network model with the referent values;
executing the identified Bayesian-Network model to determine the existence of the output variable and the probability that the specific event will occur;
creating conditional links based on the conditional probability table between the output variable of the Bayesian-Network model and the key variables of the ontological models;
the output variable of the Bayesian-Network model, the conditional links, and the ontological models together defining a dynamic ontology;
storing the dynamic ontology.
